(19) United States
(12) Patent Application Publication
(10) Pub. No.: US 2009/0057507 A1
(43) Pub. Date: Mar. 5, 2009

(54) CardHook

(75) Inventor: Nilo Discartin Ventura, Hayward, CA (US)

Correspondence Address: NILO DISCAKTIN VENTURA, 688 WOODLAND AVE., HAYWARD, CA, 94544, US

(73) Assignee: Mr. Nilo Ventura, Hayward, CA (US)

(21) Appl. No.: 11/847,968

(22) Filed: Aug. 30, 2007

(51) Int. Cl. F16B 45/00

(52) U.S. Cl. 248/205.1; 248/304

(57) ABSTRACT

Keeping hair Dryers, cellphones and other personal devices off the floor and countertops have always been a problem. The CardHook is the most convenient and quick solution to a: hanging hair dryer and other similar small electrical devices such as hair trimmers and curling iron; and b: as a cradle for cell phone or other small media players. It's held in place by plug and outlet and therefore has no installation required. Unlike regular hooks that are used today, the CardHook can be easily transported from one outlet to the next simply by disconnecting the plug, leaving no unsightly holes or marks on the wall behind.

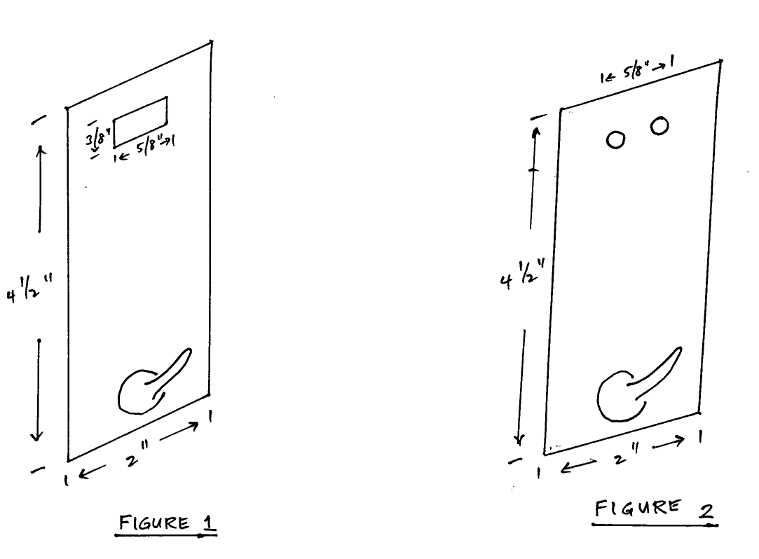

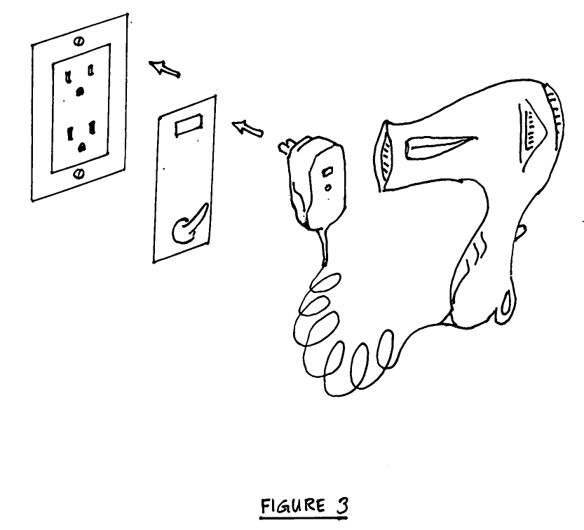

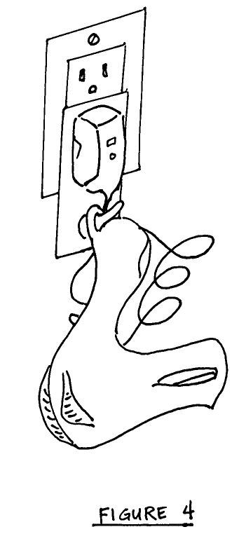

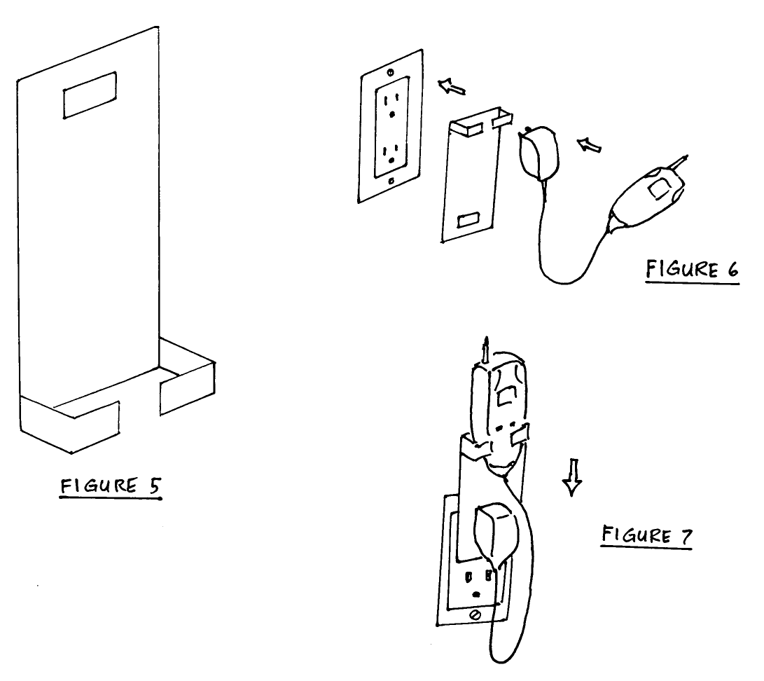

This invention called CardHook is an instant hanging hook that requires no drilling on the wall, no screws, no suction cups and no adhesive. This CardHook is primarily for a: hanging Hair Dryers and other similar small electrical devices such as hair trimmers, curling irons that come with a plug and hook on the handle; and b: as cradle for cellphone and other small portable media players. Unlike conventional hooks, the upper part of the CardHook rests flat between the electrical outlet and transformer/plug and basically hangs from the two prongs of the plug. At the lower end of the CardHook is the actual hook to be used for hanging and/or cradling the electrical device. FIG. 1 shows the front view of the CardHook which is made of thin rectangular sturdy plastic similar to a credit card. FIG. 1 illustrates the design of the CardHook which consists of a hook at the bottom (lower end), and a hanger which is a rectangle cut-out on the top end. FIG. 1 also shows the measurements of the CardHook which are: Length—4½″ or longer, Width—2″, Cut-Out(hanger) Length—⅜″, Cut-Out(hanger) Width—⅝″, Hook Size—Varies. FIG. 2 shows an alternate front view design of the CardHook's hanger which uses two punched holes that are large enough in diameter for inserting each of the metal prongs of the electrical plug. FIG. 2 also illustrates the distance between the two holes as equal to the distance between the metal prongs of the plug. The electrical outlet and plug when connected together hold and support the CardHook. To use the CardHook, the electrical outlet must be located above the counter or mid-way above the floor. The plug's prongs are inserted first into the CardHook's hanger then plugged into the lower electrical outlet (see Drawings FIGS. 3 and 6). FIG. 3 shows the correct way of using the CardHook for hanging a Hair Dryer. FIG. 3 shows the electrical outlet, CardHook, and Hair Dryer with two arrows pointing to the direction of the outlet. Following the direction of the arrows in FIG. 3, the plug's prongs are inserted first into the CardHook's hanger and then plugged into the lower electrical outlet. The CardHook is ready for use once the plug is fully secured/attached to the electrical outlet and the CardHook rests firmly between the outlet and the plug (like a sandwich) as shown in Drawings FIGS. 4 and 7. FIG. 4 shows a completely secured CardHook which is held in place by the electrical outlet and plug. FIG. 4 also shows its practical use with a Hair Dryer hanging from the hook of a CardHook. As mentioned in this specification, this CardHook can be used as a cradle for cellphones and other similar small portable devices while charging simply by modifying its hook from a single hook to a claw hook. FIG. 5 shows the front view of the CardHook with L-shaped claws at the bottom designed to hold a cellphone and other similar devices. FIG. 6 shows the electrical outlet, a CardHook which is turned upside down (L-Shaped Claws are on top and the hanger is at the lower end), a cellphone and two arrows pointing to the direction of the outlet. Following the direction of the arrows in FIG. 6, the plug's prongs are inserted first into the CardHook's hanger and then plugged into the upper or lower electrical outlet. FIG. 7 shows the practical application of the CardHook as a cradle for cellphone while it's plugged into the electrical outlet. As shown by the arrow pointing down in FIG. 7, once the CardHook is firmly held in place between the Plug and outlet, the cellphone unit can be inserted down the cradle until the L-Shaped claws prevents it from sliding down.

This substitute specification contains no new matter.

What is claimed is:

1. A hook made of thin rectangle sturdy plastic like a credit card (see Drawings FIG. 1). It consists of a hook (or L-Shaped Hook Claws forming a cradle as shown in Drawings FIG. 5) at the bottom (lower end), and a hanger which is a rectangle Cut-Out on the top end. The size of the CardHook could be approximately 4½″ in length (or longer) and 2″ in width. The cut-out (hanger) is about ⅜″ in length and ⅝″ in width (the approximate distance between the two metal prongs of an electrical device's plug). An alternate design of the hanger (see Drawings FIG. 2) is two punched holes that are big enough in diameter for inserting each of the metal prongs of the electrical plug. The distance between the two holes is equal to the distance between the metal prongs of the plug. The actual hook or cradle located at the bottom (Lower end) of the card may vary in shape. The CardHook's color may also vary or could be transparent.
